(19) United States
(12) Patent Application Publication
(10) Pub. No.: US 2010/0199567 A1
(43) Pub. Date: Aug. 12, 2010

(54) VEHICLE DOOR OPENING/CLOSING APPARATUS

(75) Inventors: Toshihiko Ishida, Aichi (JP); Tsutomu Takeuchi, Aichi (JP); Naoya Oku, Aichi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi, Aichi (JP)

(21) Appl. No.: 12/676,164

(22) PCT Filed: Nov. 17, 2008
(86) PCT No.: PCT/JP2008/070871

§ 371 Date: Mar. 3, 2010

(30) Foreign Application Priority Data
Nov. 22, 2007 (JP) 2007-303360

(51) Int. Cl. E05F 15/14

(52) U.S. Cl. 49/360

(57) ABSTRACT

A vehicle door opening/closing apparatus includes a rail for a sliding door fixed to the outside of a vehicle cabin and extending along a front-back direction of the vehicle, a support member for supporting the sliding door and movable along the rail, first and second pulleys supported respectively to opposed longitudinal ends of the rail, a cable turned around by the first and second pulleys and retained to the support member, thus being arranged in the form of a loop and a drive unit for rotatably supporting a drive wheel around which the cable is wound and configured for moving the support member back and forth according to a rotational direction of the drive wheel, the drive unit being fixed to the side of vehicle cabin. The drive unit is supported to the rail such that the drive unit is pivotable between a first posture where the drive unit projects relative to an attaching face of the rail to be attached to a vehicle body and a second posture where the drive unit is disposed along said attaching face.

### TECHNICAL FIELD

The present invention relates to a vehicle door opening/closing apparatus for opening/closing a sliding door provided in a vehicle. More particularly, the invention relates to a vehicle door opening/closing apparatus including a rail for a sliding door fixed to the outside of a vehicle cabin and extending along a front-back direction of the vehicle, a support member for supporting the sliding door and movable along the rail, first and second pulleys supported respectively to opposed longitudinal ends of the rail, a cable turned around by the first and second pulleys and retained to the support member, thus being arranged in the form of a loop, and a drive unit for rotatably supporting a drive wheel about which the cable is wound and configured for moving the support member back and forth according to a rotational direction of the drive wheel, the drive unit being fixed to the vehicle cabin side.

### BACKGROUND ART

As an example of the vehicle door opening/closing apparatus of the above-noted type, Patent Document 1, for example, discloses a vehicle door opening/closing apparatus including a rail provided on the outer side of the vehicle cabin, a supporting member for supporting the sliding door and movable along the rail, a front pulley supported to a front end of the rail, a drive unit provided inside the vehicle cabin, a rear pulley provided on the outside of the vehicle cabin more rearwardly of the rear end of the rail, and a further drive unit provided in on the inner side of the vehicle cabin. This door opening/closing apparatus includes two cables, one for door opening, the other for door closing, and one terminal end of each cable is coupled to be wound about and paid out from drive wheel of the drive unit. The other terminal end of each cable is extended to the outside of the vehicle cabin through a hole portion provided rearwardly of the rail of the vehicle body, with one being turned around the rear pulley and retained to the support member, the other being turned around the front pulley and connected to the support member. With this, depending on the direction of rotation of the drive member, the support member is moved back and forth on the rail.

Patent Document 1: Japanese Patent Application “Kokai” No. 8-232536 (claim 1 and FIG. 6).

### DISCLOSURE OF THE INVENTION

However, with the above-described vehicle door opening/closing apparatus, at the time of assembling of the apparatus to the vehicle, it is needed to arrange the length of the cable extended from the inside of the vehicle cabin, within the rail. So, the assembly of the apparatus to the vehicle was difficult.

The present invention has been made in view of the above-described problem and its object is to provide a vehicle door opening/closing apparatus can be easily assembled to the vehicle.

According to the first characterizing feature of the present invention, the apparatus comprises:

a rail for a sliding door fixed to the outside of a vehicle cabin and extending along a front-back direction of the vehicle;

a support member for supporting the sliding door and movable along the rail,

first and second pulleys supported respectively to opposed longitudinal ends of the rail;

a cable turned around by the first and second pulleys and retained to the support member, thus being arranged in the form of a loop; and

a drive unit for rotatably supporting a drive wheel about which an intermediate length portion of the cable is wound and configured for moving the support member back and forth according to a rotational direction of the drive wheel, the drive unit being fixed to the vehicle cabin side;

wherein said drive unit is supported to the rail such that the drive unit is pivotable between a first posture where the drive unit projects relative to an attaching face of the rail to be attached to a vehicle body and a second posture where the drive unit is disposed along said attaching face.

With the above-described construction, the cable in the form of a loop is disposed in advance between the pulleys provided at the opposed ends of the rail and the drive unit is supported to the rail, so that the apparatus is integrated. Accordingly, at the time of the assembly of the apparatus to the vehicle, there is no need for laying out the cable.

Further, in case e.g. the drive unit is disposed on the inner side of the vehicle cabin through a hole portion provided in the vehicle body, if the drive unit is rendered into the first posture where the unit projects relative to the attaching face of the rail, this attaching face will be brought into opposition to the vehicle body, so that the drive unit will project toward the hole portion. Therefore, the drive unit can be easily inserted into the hole portion. On the other hand, after its insertion into the hole portion, the drive unit may be rendered into the second posture where the unit is disposed along the attaching face, so that the unit can be fixed in a reliable manner. As a result of the above, there can be obtained a vehicle door opening/closing apparatus having convenience of assembly.

According to the second characterizing feature of the present invention, the apparatus further comprises a holding mechanism provided between said rail and said drive unit and configured to hold said drive unit under said first posture.

With this construction, when the rail and the drive unit are to be assembled to the vehicle, the drive unit can be held under the first posture in a reliable manner, so that the assembly of the apparatus can be further facilitated.

According to the third characterizing feature of the present invention, an axis of said cable is aligned with a pivotal axis of said drive unit.

In the event of misalignment between the axis of the cable and the pivotal axis of the drive unit, when the posture of the drive unit is switched over, this results in a change in the path length of the cable, thus resulting in a change in the cable tension. Therefore, it may become difficult to maintain appropriate cable tension before and after the posture switchover of the drive unit. Then, by aligning the axis of the cable with the pivotal axis of the drive unit as in the above-described construction, the path length of the cable is maintained constant, thus preventing change in the cable tension in association with posture switchover of the drive unit. As a result, the performance of the apparatus can be improved.

According to the fourth characterizing feature of the present invention, on the side of the attaching face of the rail to the vehicle body, there is provided a drive unit attachment support member for attachment of the drive unit, and this drive unit attachment support member supports said drive unit such that the drive unit is pivotable between said first posture and said second posture. With this, there can be obtained a vehicle door opening/closing apparatus having convenience of assembly.

According to the fifth characterizing feature of the present invention, said second posture is a posture where said drive unit projects toward the lower side of said rail. With this, there can be obtained a vehicle door opening/closing apparatus having convenience of assembly.

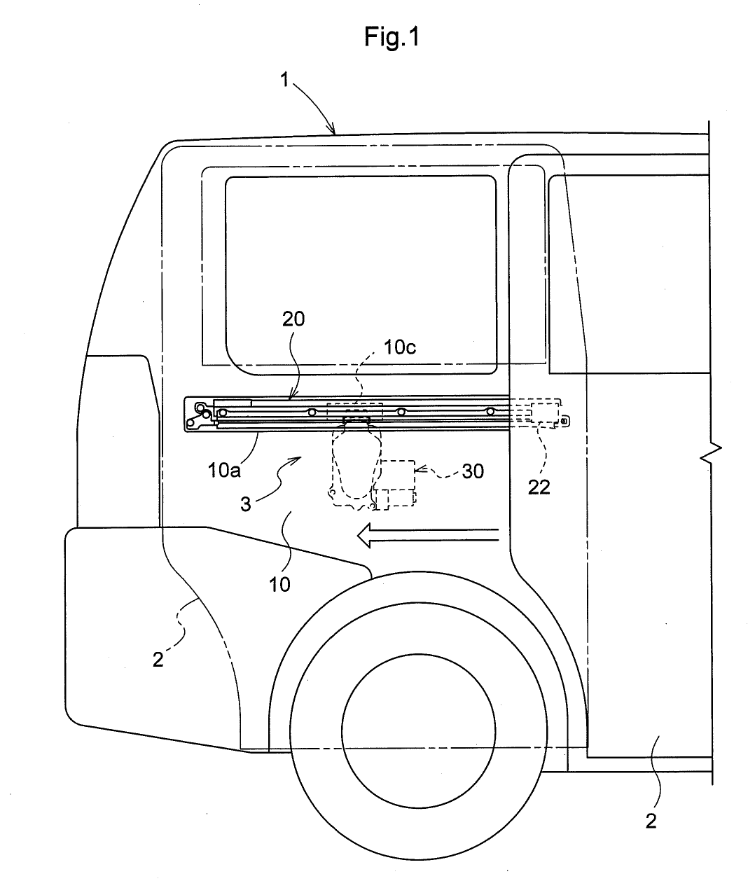

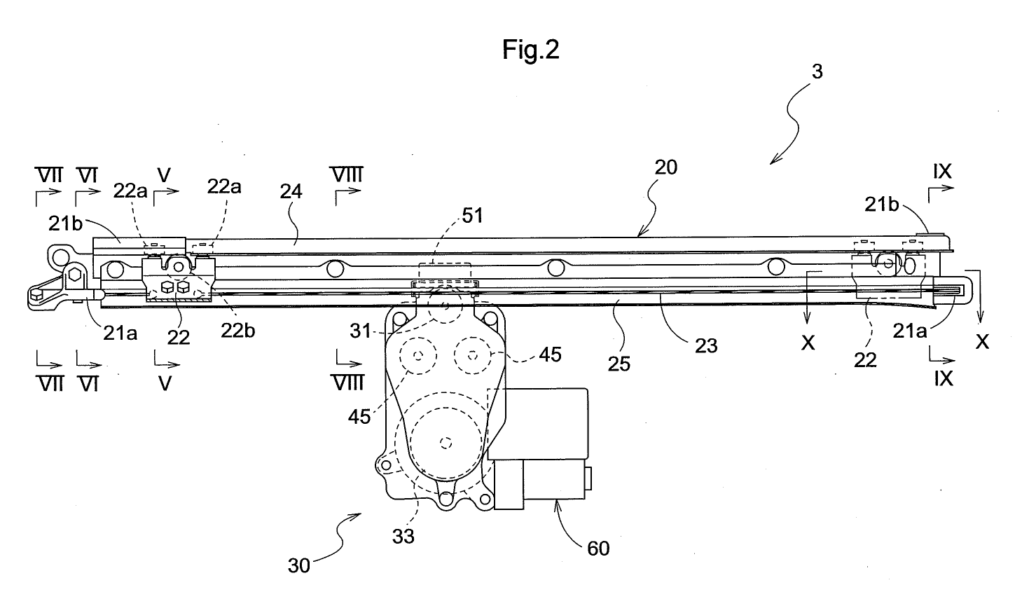

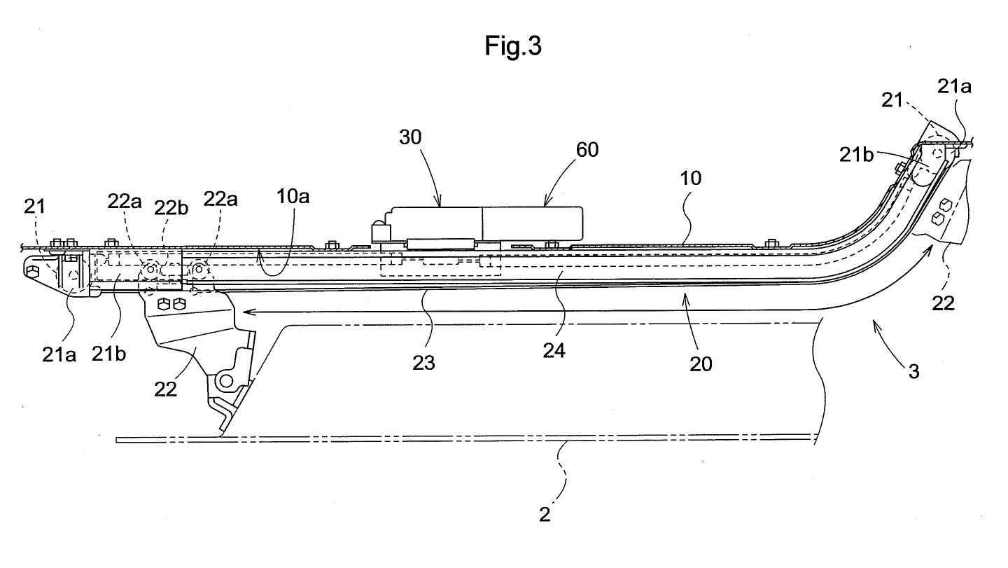

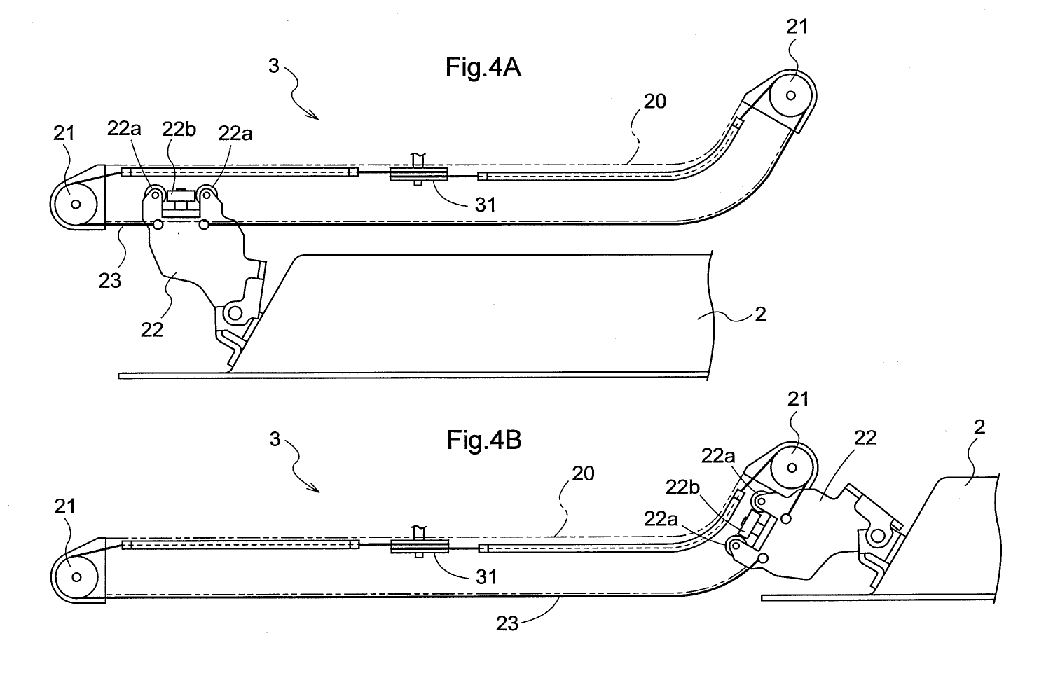

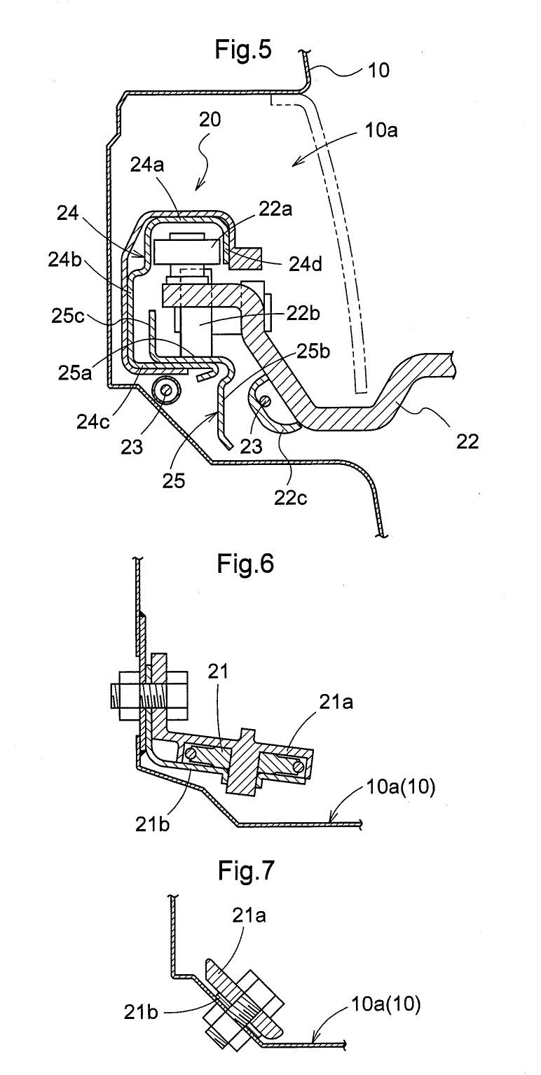

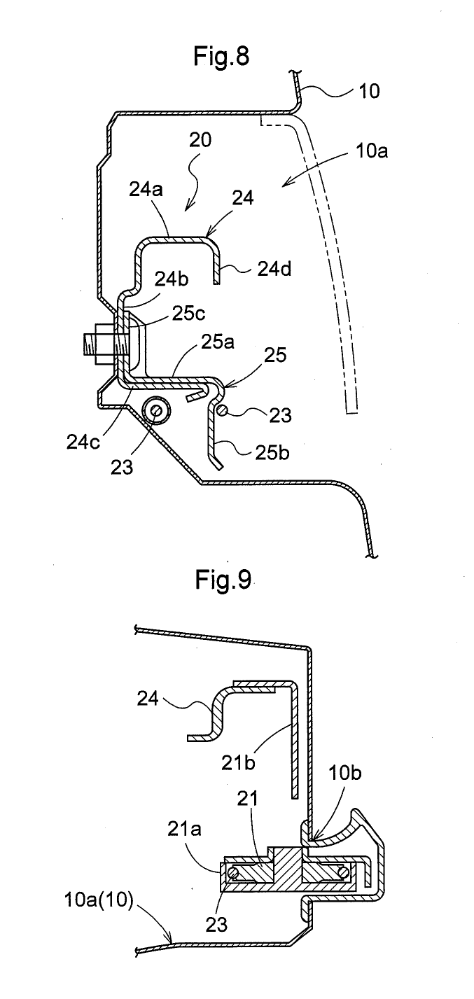

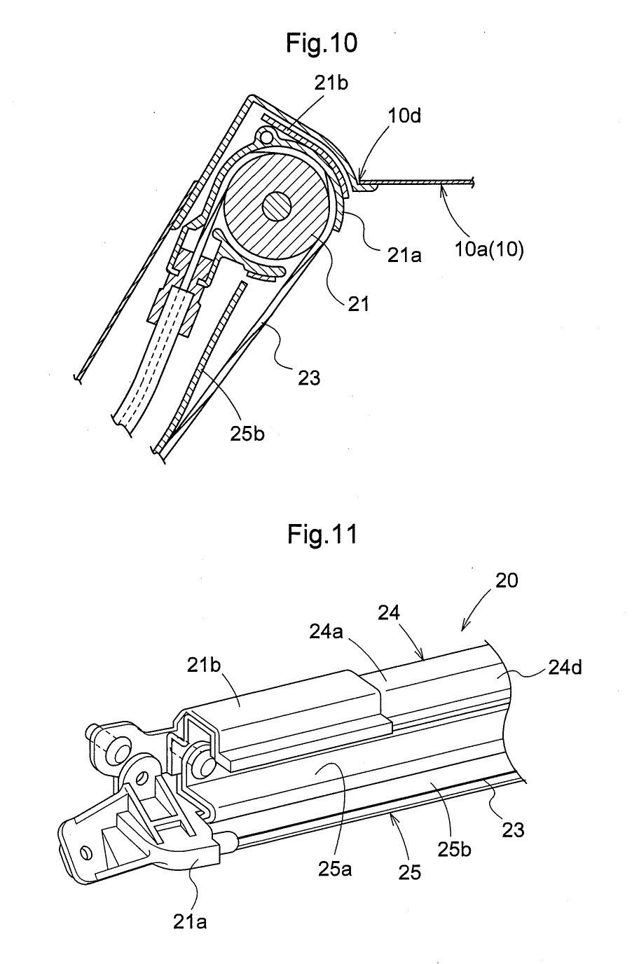

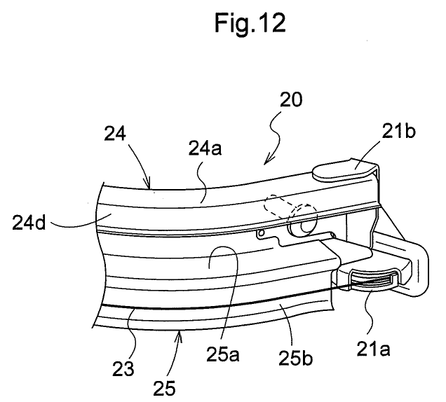

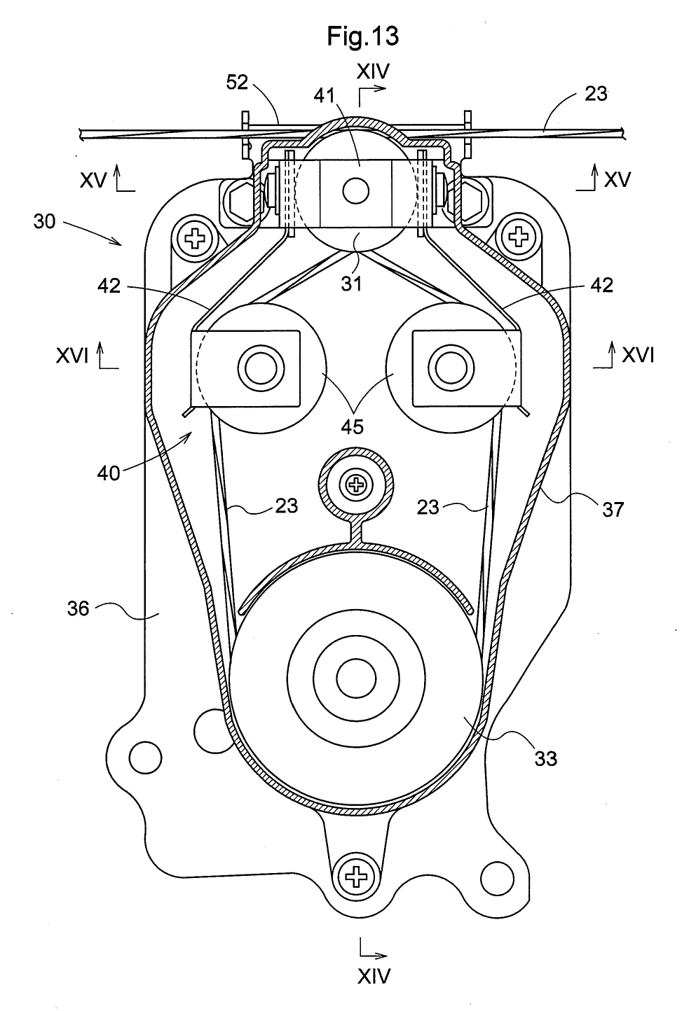

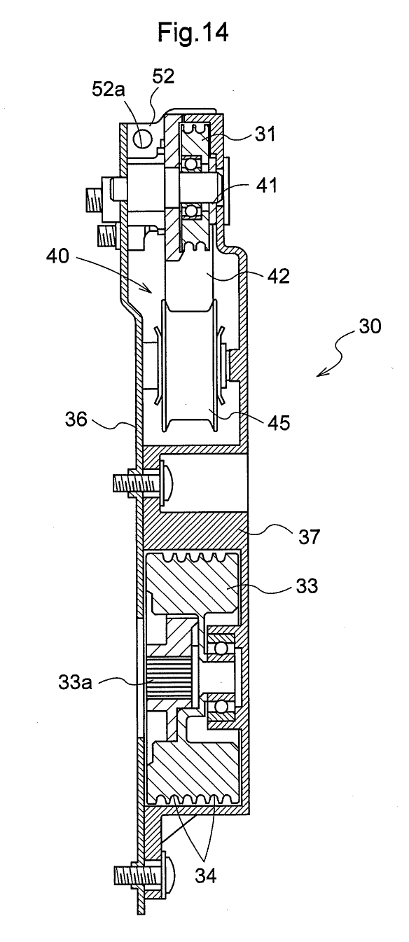

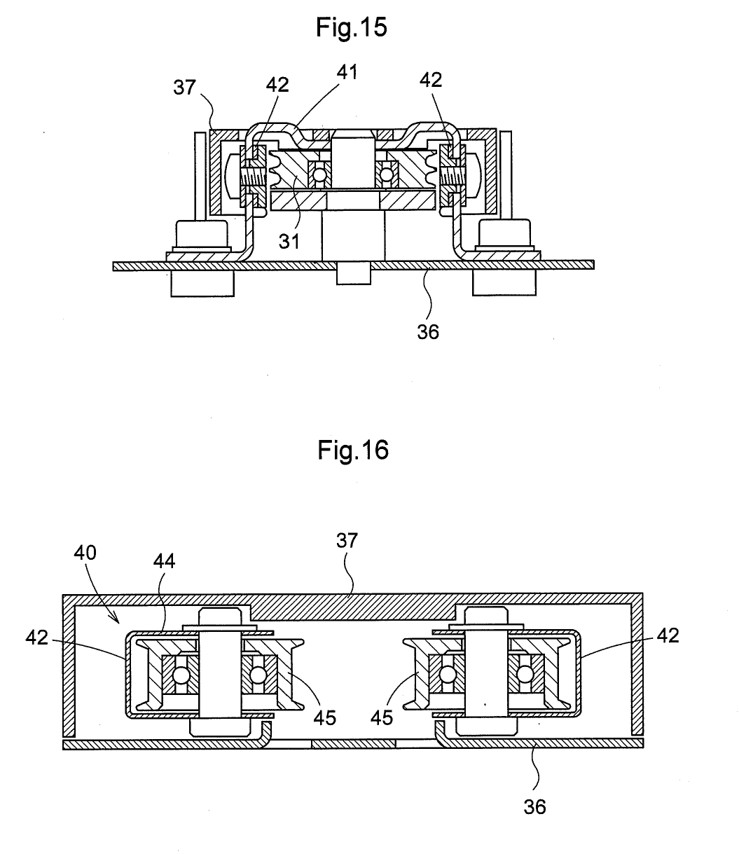

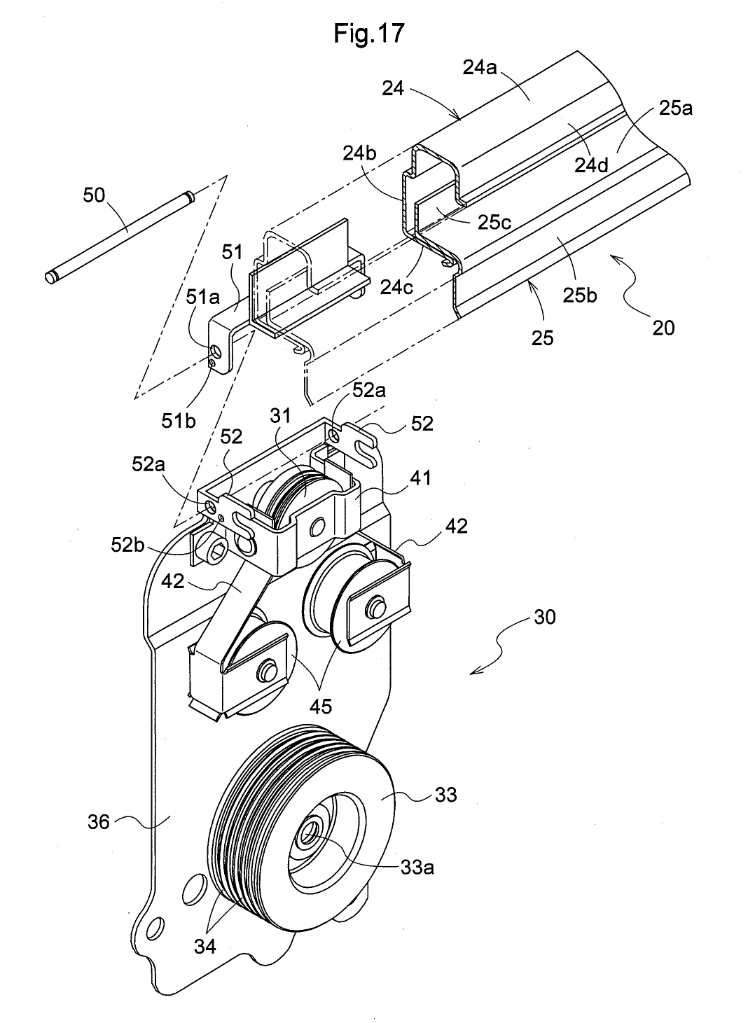

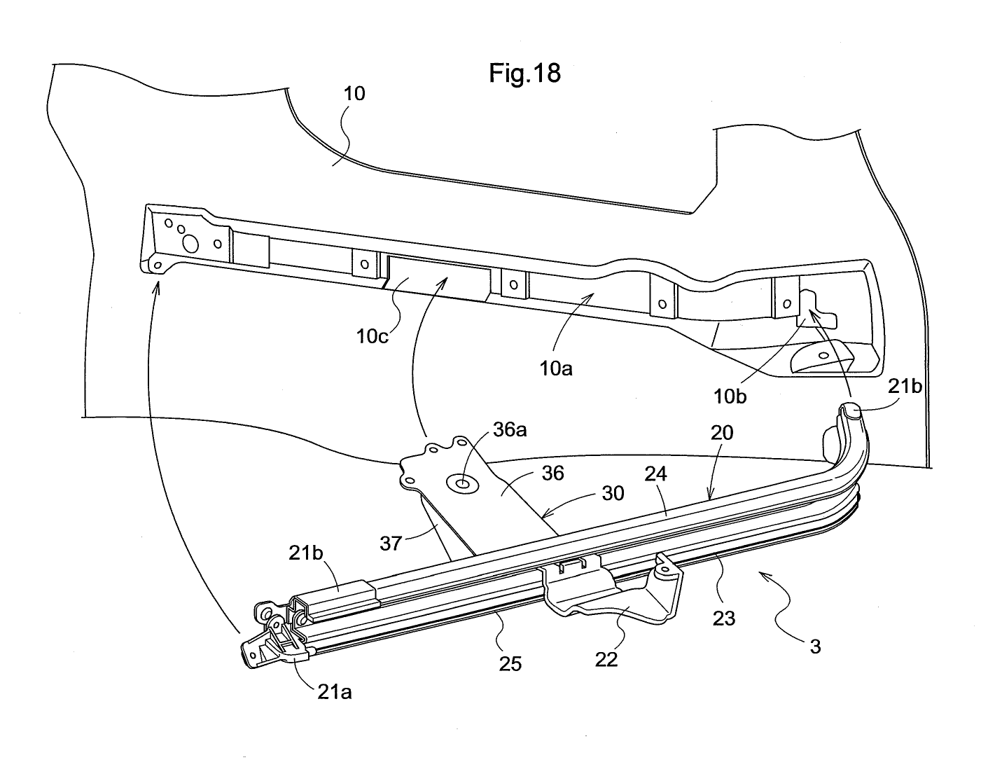

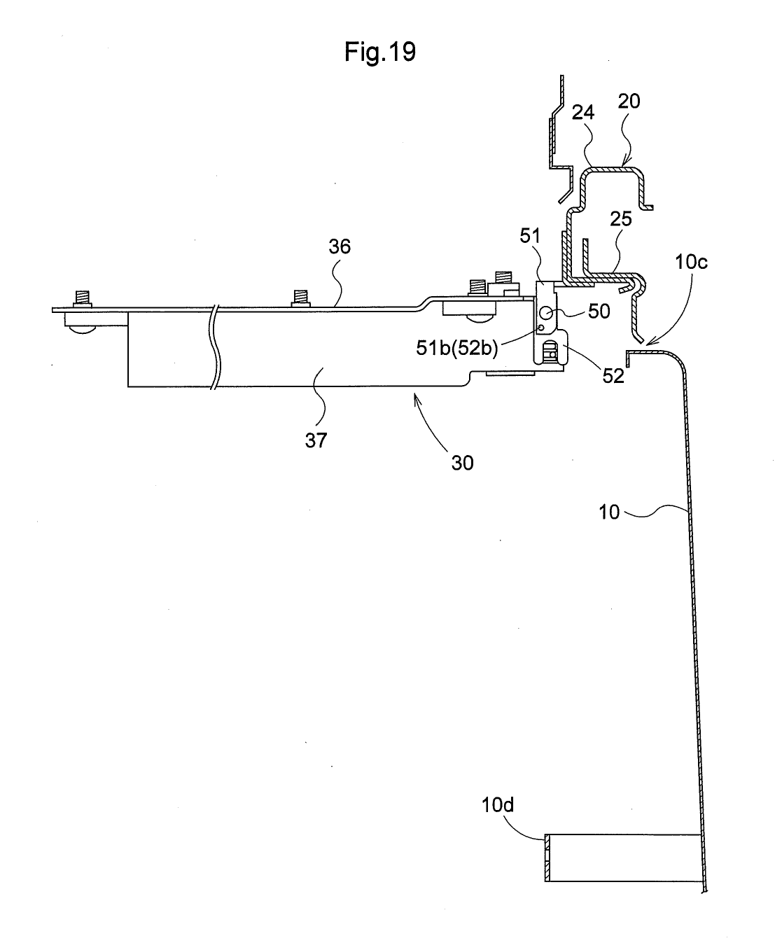

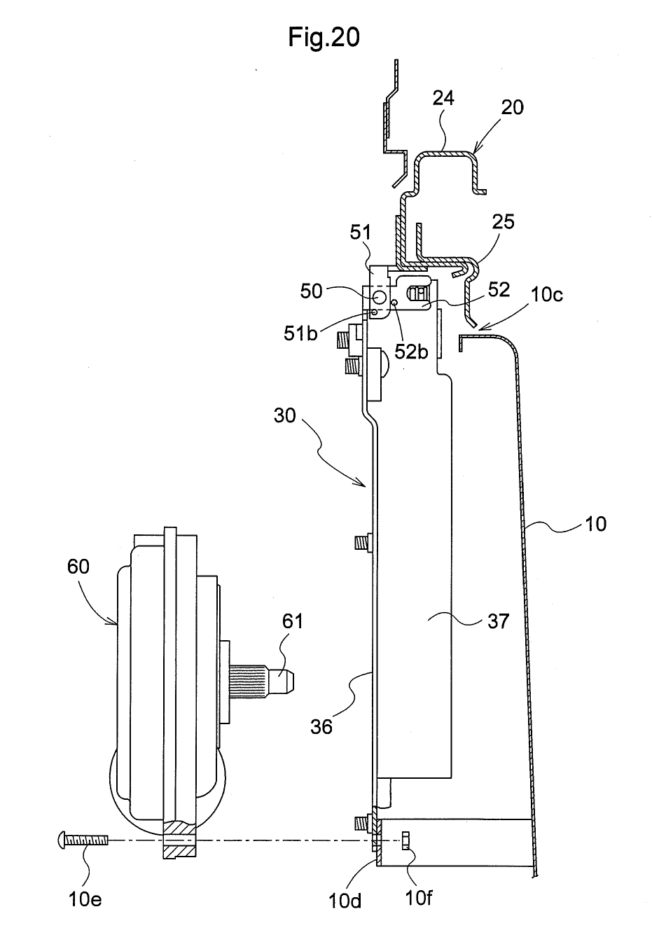

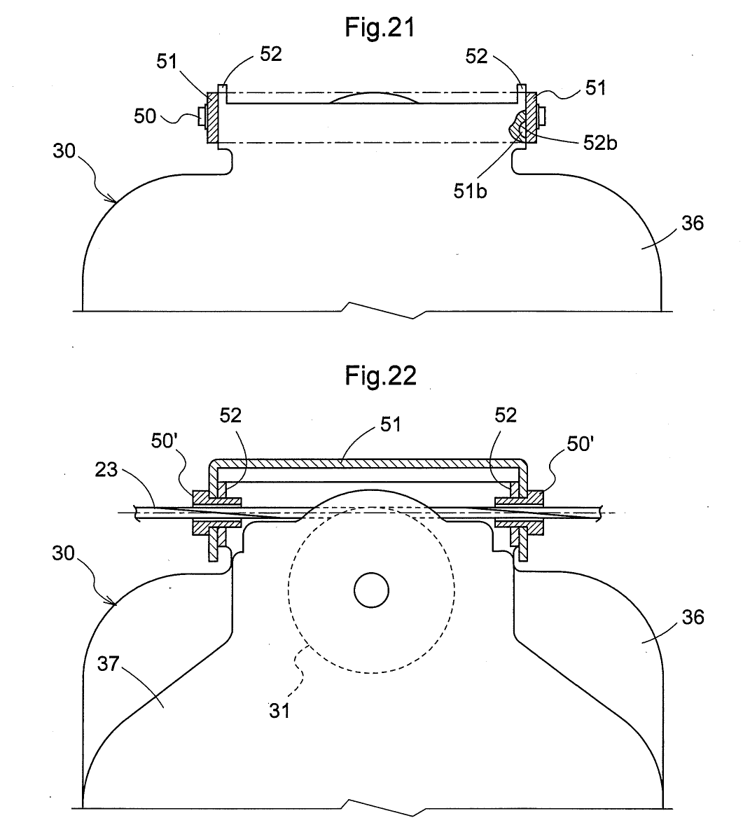

### BRIEF DESCRIPTION OF THE DRAWINGS

[FIG. 1] is a side view of a vehicle having a vehicle door opening/closing apparatus relating to the present invention,

[FIG. 2] is a side view showing the vehicle door opening/closing apparatus relating to the present invention,

[FIG. 3] is a plane view showing the vehicle door opening/closing apparatus relating to the present invention,

[FIG. 4] are views illustrating operations of the vehicle door opening/closing apparatus relating to the present invention,

[FIG. 5] is a section view taken along V-V in FIG. 2,

[FIG. 6] is a section view taken along VI-VI in FIG. 2,

[FIG. 7] is a section view taken along VII-VII in FIG. 2,

[FIG. 8] is a section view taken along VIII-VIII in FIG. 2,

[FIG. 9] is a section view taken along IX-IX in FIG. 2,

[FIG. 10] is a section view taken along X-X in FIG. 2,

[FIG. 11] is a perspective view showing a rear end portion of a rail unit,

[FIG. 12] is a perspective view showing a front end portion of the rail unit,

[FIG. 13] is a view showing a drive unit,

[FIG. 14] is a section view taken along XIV-XIV in FIG. 13,

[FIG. 15] is a section view taken along XV-XV in FIG. 13,

[FIG. 16] is a section view taken along XVI-XVI in FIG. 13,

[FIG. 17] is a view illustrating supporting of the drive unit to the rail unit,

[FIG. 18] is a perspective view illustrating assembly of the vehicle door opening/closing apparatus to a vehicle,

[FIG. 19] is a section view illustrating assembly of the vehicle door opening/closing apparatus to the vehicle,

[FIG. 20] is a section view illustrating assembly of the vehicle door opening/closing apparatus to the vehicle,

[FIG. 21] is a view showing a holding mechanism, and

[FIG. 22] is a view showing a further embodiment.

### BEST MODE OF EMBODYING THE INVENTION

Embodiments of the present invention will be described with reference to the accompanying drawings. FIG. 1 is a side view of a vehicle 1 having a sliding door 2. This vehicle 1 includes a vehicle door opening/closing apparatus 3, so that the sliding door 2 can be automatically opened/closed.

FIG. 2 is a side view of the vehicle door opening/closing apparatus 3 as being attached to the vehicle 1. FIG. 3 is its plane view. As shown in FIG. 2 and FIG. 3, the vehicle door opening/closing apparatus 3 includes a rail unit 20, a drive unit 30 supported to the rail unit 20, and a power unit 60 for providing power to the drive unit 30. The rail unit 20 is fixed to the inside of a concave portion 10a that is formed in a lateral face of a vehicle body 10 on the outer side of the vehicle cabin and e.g. adjacent the height-wise approximate center thereof and that extends along the front-back direction. The drive unit 30 is inserted into the vehicle cabin through a hole portion 10c formed in the recess portion 10a and communicating to the inside of the vehicle cabin, and fixed under this condition to the vehicle body 10. With this, the vehicle door opening/closing apparatus 3 is fixed to the vehicle 1. Further, the power unit 60 too is fixed to the inner side of the vehicle cabin. Incidentally, the attaching position of the rail unit 20 is not limited to the vicinity of the height-wise approximate center of the vehicle body 10. This position can be any other position, such as a height-wise lower side of the vehicle body 10.

The rail unit 20, as shown in FIG. 2 and FIG. 3, includes rails 24, 25, a support bracket 22 (corresponding to the “support member” in the present invention) for supporting the sliding door 2 and movable along the rail, and a first pulley 21 and a second pulley 22 which are supported respectively to opposed longitudinal ends of the rails 24, 25. As shown in FIG. 3, this rail unit 20 is curved, at its predetermined region on the front side of the vehicle 1, to the inner side of the width of the vehicle.

In this rail unit 20, as shown in FIG. 4, a cable 23 is turned around by the first and second pulleys 21, 21, and the opposed ends of the cable 23 are retained to the support bracket 22, so that the cable 23 is arranged in the form of a loop around the rails 24, 25. Further, an intermediate length portion of the cable 23 is wound around a drive wheel 33 of a drive unit 30. As shown in FIG. 3, the support bracket 22 is pulled by the cable 23 according to a rotational direction of the drive wheel 33, thus being moved back and forth between the opposed ends of the rails.

To the portion of the bracket 22 on the outer side of the rails 24, 25, the sliding door 2 is supported to the support bracket 22 about a vertically extending pivotal axis, whereby the sliding door 2 is movable back and forth between a full-open position (FIG. 4(a)) and a full-closed position (FIG. 4 (b)), and in the full-open condition, the sliding door 2 is pivoted so that the sliding door 2 becomes substantially flush with the lateral face of the vehicle 1.

As shown in FIG. 8, the rail includes a guide rail member 24 for guiding the support bracket 22 and a load rail member 25 for supporting the loads of the support bracket 22 and the sliding door 2. As shown in FIG. 8, the guide rail member 24 is a substantially C-shaped member having a top plate portion 24a, a back plate portion 24b, a bottom plate portion 24c and an extension portion 24d extending downward from the top plate portion 24a. Between the upper portion of the back plate portion 24b and the extension portion 24d, guide rollers 22a of the support bracket 22 to be described later are held. Further, the load rail member 25 includes a roller support portion 25a to which a load roller 22b of the support bracket 22 to be described later is supported, a cable support portion 25b extending downward from the roller support portion 25a, and a back plate portion 25c extending upward from the opposite side of the roller support portion 25a to its side where the cable support portion 25b extends. Inside the guide rail member 24, the back plate portion 25c and the roller support portion 25a are positioned, with the cable support portion 25b extending downward, and under this condition, the guide rail member 24 and the load rail member 25 are integrated together in advance. Incidentally, the guide rail member 24 and the load rail member 25 are integrated together by fastening the respective back plate portions 24b, 25c together with a bolt (not shown) for instance. However, the integration of the guide rail member 24 and the load rail member 25 is not limited to the bolt-fastening integration described above, but can be any other arrangement of using a component integrally forming the guide rail 24 and the load rail 25 for instance.

As shown in FIG. 6 and FIG. 11, the first pulley 21 is rotatably mounted within a pulley case 21a and this pulley case 21a is supported to a rear end portion of the rail via a joint member 21b fixed to the rear end portion of the rail. Further, as shown in FIG. 9, FIG. 10 and FIG. 12, the second pulley 21 too, like the first pulley 21, is rotatably supported within a pulley case 21a and this pulley case 21a is supported to a front end portion of the rail via a joint member 21b fixed to the front portion of the rail.

As described above, the first pulley 21 and the second pulley 21 are integrated with the rail. In this respect, as shown in FIG. 11 and FIG. 12, the first pulley 21 and the second pulley 21 are disposed at positions lower than the roller support portion 25a and along this roller support portion 25a, so that the pulleys 21, 22 are rotatable about a rotational axis normal to the roller support portion 25a. With this arrangement of the first pulley 21 and the second pulley 21, it is possible to avoid interference thereof with the support bracket 22. That is to say, since the roller support portion 25a can be disposed at the positions in the immediate vicinity of the two pulleys 21, the rail length can be effectively utilized.

As shown in FIG. 5, at the rail inner side portion of the support bracket 22, the pair of guide rollers 22a each having a rotational axis extending along the vertical direction of the vehicle 1 and the load roller 22b having a rotational axis extending along the width direction of the vehicle 1 are rotatably connected, respectively. The guide rollers 22a are movable as rolling along inside of the guide rail member 24 so as to guide the support bracket 22 relative to the rail. On the other hand, the load roller 22b is movable on the load rail member 25 while supporting the load of the sliding door 2 supported to the support bracket 22. Incidentally, the guide rollers 22a are retained to the guide rail member 24 and also the load roller 22a is placed in contact with the roller support portion 25a, whereby the support bracket 22 is provided integrally with the rails, in advance.

As shown in FIG. 4 and FIG. 5, the cable 23 is turned around by the first pulley 21 and the second pulley 21 and the opposed ends of the cable 23 are retained to a retaining portion 22c of the support bracket 22 and the cable 23 is laid in the form of a loop about the rails and provided integrally with the rails in advance. In this embodiment, as shown in FIG. 5, FIG. 8, FIG. 11 and FIG. 12, the portion of the loop-like cable 23 which portion is retained to the support bracket 22 and disposed on the outer side of the vehicle is disposed along the cable support portion 25b and the further portion located on the inner side of the vehicle is disposed on the back face of the cable support portion 25b.

Further, as shown in FIG. 5, the cable support portion 25b is formed at a portion of the support bracket 22 on the outer side of the rail and lower than the roller support portion 25a, so that the cable 23 is disposed downwardly of the roller support portion 25a. With this arrangement, interference between the guide rollers 22a and the load roller 22b and the cable 23 is prevented.

As described above, in the instant embodiment, the rails 24, 25, the first pulley 21, the second pulley 21 and the support bracket 22 are integrated and pre-assembled as the integral rail unit 20.

As shown in FIG. 13 and FIG. 17, the drive unit 30 includes a guide pulley 31 for guiding the cable 23 to the inside of the drive unit 30, a tension mechanism 40 for applying a tension to the cable 23, and the drive wheel 33 about which the intermediate portion of the cable 23 is wound and configured to move the support bracket 22 back and forth according to the rotation direction of the drive wheel 33. These components are affixed to a base plate 36 and covered with a unit case 37. Incidentally, FIG. 13 shows a condition wherein the cable 23 is arranged in the drive unit 30.

As shown in FIG. 14, the drive wheel 33 is formed as a cylindrical body and in the outer peripheral face of this cylindrical body, an engaging groove 34 is formed. This engaging groove 34 is for coming into engagement with successive length portions of the cable 23 and the cable 23 is wound about the drive wheel 33 along the engaging groove 34. Further, as shown in FIG. 13 and FIG. 14, at the center of the drive wheel 33, there is defined a hole portion 33a into which a power shaft 61 of the drive unit 30 as a power source is inserted. Incidentally, in the base plate 36, at a position thereof corresponding to the hole portion 33a of the drive wheel 33, there is provided a hole portion 36a for allowing insertion of the power shaft 61.

As shown in FIG. 13, the guide pulley 31 guides the cable 23 extending from the rail unit 20 to the drive wheel 33 and guides the cable 23 past the drive wheel 33 back to the rail unit 20. As shown in FIG. 14 and FIG. 15, the guide pulley 31 includes a groove for engagement with the cable 23 (“reel-in cable 23” hereinafter) reeled in from the side of the rail unit 20 toward the outer peripheral face of the drive wheel 33 and a further groove for engagement with the cable 23 reeled out (paid out) from the outer peripheral face of the drive wheel 33 to the side of the sliding door 2 (“reel-out cable 23” hereinafter).

As shown in FIG. 13 and FIG. 16, the tension mechanism 40 includes plate springs 42 affixed to the pulley cover 41 and elastically deformable. To the inner side face of the opposed sides of the pulley cover 41, each plate spring 42 is fixed at its one end thereof. As the plate spring 42 is fixed to the later face of the pulley cover 41, the plate spring 42 is located on the outer side of the length of the cable 23 wound around and between the guide pulley 31 and the drive wheel 33. To these tension pulleys 45, the reel-in cable 23 engages one of them and the reel-out cable 23 engages the other of the same.

As shown in FIG. 13, when the cable 23 retained to the support bracket 22 (see FIG. 4) and forming a loop across and between the fixed pulleys, the guide pulley 31 and the drive wheel 33 comes into engagement with the tension pulleys 45, the plate spring 42 is displaced inward, therefore, the cable 23 receives via the tension pulleys 45 outwardly oriented tension.

As shown in FIG. 17, the drive unit 30 is supported to the rail unit 20 such that the drive unit 30 is pivotable between a first posture where the drive unit 30 projects relative to an attaching face of the rail unit 20 to be attached to the vehicle body 10 and a second posture where the drive unit 30 is disposed along the attaching face. More particularly, to the side of the attaching face of the rail unit 20 to be attached to the vehicle body 10, there is affixed a support bracket 51 (corresponding to the “drive unit attachment support member” in the present invention). Further, on the side of the drive unit 30, there is formed a bearing portion 52. As a pin 50 is inserted between a hole portion 51a of the support bracket 51 and a hole portion 52a of the bearing portion 52, the drive unit 30 is supported to the rail unit 20. Incidentally, as shown in FIG. 21, between the support bracket 51 and the bearing portion 52, there are respectively provided a convex portion 51b (52b) and a concave portion 52b (51b) which come into engagement with each other when the drive unit 30 is at the first posture, thereby to hold the position of this drive unit 30. Here, the convex portion 51b (52b) and the concave portion 52b (51b) together function as a “holding mechanism” in the present invention.

The power unit 60 (see FIG. 2) is an integral unit including a reversible motor rotatable in both forward and reverse directions, an electromagnetic clutch for engaging/disengaging the power transmission between the drive unit 30 and the motor, a controlling section for controlling the operations of these components, etc. When the motor is rotated in one direction and this rotational force is transmitted to the drive wheel 33, the drive wheel 33 too is rotated in the corresponding direction thereby to reel in the length of cable 23 in the door closing direction, thereby to close the sliding door 2. On the other hand, when the motor is rotated in the reverse direction, the rotational direction of the drive wheel 33 too is reversed, thereby to open the sliding door 2.

Next, the assembly of the vehicle door opening/closing apparatus 3 will be explained. As shown in FIG. 18, in the lateral face on the outer side of the vehicle cabin of the vehicle 1, there is formed a concave portion 10a extending along the front-back direction. At the substantially center portion of the concave portion 10a, there is provided a hole portion 10c communicating to the side of the vehicle cabin and adjacent the front end of the concave portion 10a, there is formed a concave portion 10b for allowing insertion of the front end of the rail unit 20. Further, at a plurality of positions along the longitudinal direction of the concave portion, there are formed holes for use in fastening the rail unit 20 to the side of the vehicle body 10 with bolts.

As shown in FIG. 18, while the drive unit 30 is maintained under the first posture, the vehicle door opening/closing apparatus 3 is accommodated within the concave portion 10 from the outer side of the vehicle cabin of the vehicle 1, then, the rail unit 20 is bolt-fastened to the vehicle body 10. In the course of this, as shown in FIG. 6 or FIG. 7, at the rear end of the rail unit 20, the pulley case 21a, the joint member 21b and the vehicle body 10 will be fastened together. Further, as shown in FIG. 8, at an intermediate portion, the guide rail member 24 and the load rail member 25 will be fastened together to the vehicle body 10. Incidentally, in the instant embodiment, for assembling the rail unit 20 to the vehicle body 10, nuts are welded to the vehicle body 10 side, so that the bolts are fastened from the outer side of the vehicle cabin.

After completion of the attachment of the rail unit 20, as shown in FIG. 19, the drive unit 30 maintained under the first posture will be pivoted downward about the pin 50, to be switched over to the second posture along the vehicle body 10 on the inner side of the vehicle cabin. In this, the engagement between the convex portion 51b (52b) and the concave portion 52b (51b) provided respectively in the support bracket 51 and the bearing portion 52 will be easily released through elastic deformation of the support bracket 51 and the bearing portion 52. With this, the posture of the drive unit 30 is switched over from the first posture to the second posture.

After the posture switchover of the drive unit 30, as shown in FIG. 20, into the hole portion 33a (see FIG. 17) of the drive pulley supported to the drive unit 30 from the vehicle cabin inner side, the power shaft 61 of the power unit 60 is inserted. Further, between the power unit 60, the drive unit 30 and an attaching seat 10d of the vehicle body 10 side, bolts 10e and nuts 10f will be fastened to each other and fixed to each other.

With the above-described procedure, the vehicle door opening/closing apparatus 3 is mounted to the vehicle body 10 from the vehicle cabin outer side and the rail unit 20 is fixed to the vehicle body 10 on the outer side of the vehicle cabin and the drive unit 30 is affixed to the vehicle body 10 on the inner side of the vehicle cabin.

As described above, as the cable 23 is arranged between the pulleys provided at the opposed ends of the rails and the drive unit 30 is supported to the rails, thus forming the integrated apparatus. Therefore, there is no need to effect the laying out operation of the cable 23 at the time of the assembly of the apparatus to the vehicle 1.

Further, the drive unit 30 can be rendered to the first posture to project toward the hole portion 10c and can be inserted into the hole portion 10c under this condition and moreover the after its insertion into the hole portion 10c, the drive unit 30 can now be switched over to the second posture along the attaching face, so that the unit 30 can be affixed in a reliable manner. Therefore, the assembly of the apparatus can be carried out very easily. Incidentally, if seal members are provided to the support bracket 51 fixed to the guide rail member 24 and the main body of the guide rail member 24, sealed condition can be maintained around the hole portion 10c of the vehicle body.

### Other Embodiments

(1) In the foregoing embodiment, as shown in FIG. 22, the axis of the cable 23 may be aligned with the pivotal axis of the drive unit 30. More particularly, the axis of the cable 23 is placed in alignment with the retaining portion of the drive unit 30 relative to the rail unit 20 and the cable 23 is inserted into a hollow portion of a hollow retaining pin 50′.

If the axis of the cable 23 is not aligned with the pivotal axis of the drive unit, with switchover of the posture of the drive unit 30, the path length of the cable 23 will be changed, thus resulting in a change in the tension of the cable 23. Therefore, before/after the posture switchover of the drive unit 30, it may become difficult to maintain the tension of the cable 23 appropriate. Then, by aligning the axis of the cable 23 with the pivotal axis of the drive unit 30 as in the above-described construction, the path length of the cable 23 can be maintained constant, thus preventing such tension change in the cable 23 associated with the posture switchover of the drive unit 30, whereby the performance of the apparatus can be improved.

(2) In the foregoing embodiment, the power unit 60 and the drive unit 30 were provided as separate components. Instead, the power unit 60 and the drive unit 30 can be integrated. Further, the power unit 60 may be assembled to the drive unit 30, prior to the assembly of the vehicle door opening/closing apparatus 3 to the vehicle 1, and then may be assembled to the vehicle 1. With this, change in the tension of the cable 23 associated with posture switchover of the drive unit 30 can be prevented, thus improving the performance of the apparatus.

(3) In the foregoing embodiment, the tension mechanism 40 was provided in the drive unit 30. However, the tension mechanism 40 may be omitted. Further, a tension mechanism 40 having a different construction from the above may be provided.

(4) In the foregoing embodiment, as the holding mechanism, the convex portion 51b (52b) and the concave portion 52b (51b) elastically engageable under the first posture were provided between the support bracket 51 and the bearing portion 52. However, the holding mechanism is not limited to the above-described one. For instance, as the holding mechanism, hole portions which become overlapped with each other under the first posture may be provided respectively to the support bracket 51 and the bearing portion 52, so that the first posture may be maintained with insertion of a pin into these hole portions. In this way, the holding mechanism may be constructed of using different members.

(5) In the foregoing embodiment, for the assembly of the rail unit 20 to the vehicle body 10, nuts were welded to the vehicle body 10 side, so that the bolts were fastened from the vehicle cabin outer side. Instead, bolts may be welded to the rail unit 20 side, so the nuts may be fastened from the vehicle cabin inner side.

(6) For fastening and fixing together the power unit 60, the drive unit 30 and the attaching seat 10d of the vehicle body 10 side, the nut 10f may be welded in advance to the attaching seat 10d, to be fastened with the bolt 10e. Further, the bolt 10e may be welded in advance to the attaching seat 10, to be fastened with the nut 10f.

(7) In the foregoing embodiment, the cable 23 was laid in the form of a loop, with retaining the opposed ends of the cable to the support bracket 22, and the intermediate length portion of the cable 23 was wound around the drive wheel 33. Instead, for instance, the cable 23 may be laid out in the form of a loop, with its opposed ends being wound around the drive wheel 33, with the intermediate length portion of the cable 23 being retained to the support bracket 22.

Further, two cables may be employed, with one end of each cable 23 being wound around the drive wheel 33, the other end thereof being retained to the support bracket 22, so that the cable 23 may be laid out in the form of a loop.

### INDUSTRIAL APPLICABILITY

The present invention is applicable to a vehicle door opening/closing apparatus for opening/closing a sliding door provided in a vehicle.

1. A vehicle door opening/closing apparatus comprising:
a rail for a sliding door fixed to the outside of a vehicle cabin and extending along a front-back direction of the vehicle;
a support member for supporting the sliding door and movable along the rail,
first and second pulleys supported respectively to opposed longitudinal ends of the rail;
a cable turned around by the first and second pulleys and retained to the support member, thus being arranged in the form of a loop; and
a drive unit for rotatably supporting a drive wheel around which the cable is wound and configured for moving the support member back and forth according to a rotational direction of the drive wheel, the drive unit being fixed to the side of vehicle cabin;
wherein said drive unit is supported to the rail such that the drive unit is pivotable between a first posture where the drive unit projects relative to an attaching face of the rail to be attached to a vehicle body and a second posture where the drive unit is disposed along said attaching face.

2. The vehicle door opening/closing apparatus according to claim 1, wherein further comprising a holding mechanism provided between said rail and said drive unit and configured to hold said drive unit under said first posture.

3. The vehicle door opening/closing apparatus according to claim 1, wherein an axis of said cable is aligned with a pivotal axis of said drive unit.

4. The vehicle door opening/closing apparatus according to claim 1, wherein on the side of the attaching face of the rail to the vehicle body, there is provided a drive unit attachment support member for attachment of the drive unit, and this drive unit attachment support member supports said drive unit such that the drive unit is pivotable between said first posture and said second posture.

5. The vehicle door opening/closing apparatus according to claim 1, wherein said second posture is a posture where said drive unit projects toward the lower side of said rail.
